(19) United States
(12) Patent Application Publication
(10) Pub. No.: US 2026/0104664 A1
(43) Pub. Date: Apr. 16, 2026

(54) IMAGE FORMING APPARATUS

(71) Applicant: SHARP KABUSHIKI KAISHA, Sakai City (JP)

(72) Inventor: Shinji YAMANA, Sakai City (JP)

(21) Appl. No.: 19/356,463

(22) Filed: Oct. 13, 2025

(30) Foreign Application Priority Data
Oct. 16, 2024 (JP) 2024-180806

(51) Int. Cl. G03G 15/20; G03G 15/23

(52) U.S. Cl. CPC G03G 15/2039; G03G 15/2032; G03G 15/2064; G03G 15/234; G03G 2215/2032

(57) ABSTRACT

An image forming apparatus comprises: one or more controllers that control a heat source and a pressure changing device and that have received image formation on one or a plurality of sheets as a print job determine whether to perform fixing condition change control, based on a humidity condition that an ambient humidity exceeds reference humidity and at least one of setting conditions of a sheet length setting and a duplex printing setting in the print job, and are allowed to perform control, as the fixing condition change control, of changing pressure of a pressing member from first pressure when the ambient humidity is the reference humidity or lower to second pressure lower than the first pressure and increasing an amount of heat supplied by a heat source to be larger than an amount of heat when the ambient humidity is the reference humidity or lower.

### CROSS-REFERENCE TO RELATED APPLICATION

The present application claims priority from Japanese Application JP2024-180806, the content of which is hereby incorporated by reference into this application.

### BACKGROUND

### 1. Field

The present disclosure relates to an image forming apparatus.

### BACKGROUND ART

An image forming apparatus such as a copy machine, a multifunctional device, a printer, or a facsimile device using an electrophotographic method includes a fixing device. In general, the fixing device is configured to form a fixing nip by pressing a fixing member such as a fixing belt with a pressing member. When a sheet passes through the fixing nip, toner and the sheet are pressurized and heated, and a toner image is fixed to the sheet. In such a fixing device, the sheet receives heat and pressure at the fixing nip and thus may be curled.

In the related art, for the purpose of preventing the sheet from being curled after duplex printing, pressure by a pressing member during printing on the first surface of the sheet in duplex printing is first pressure and pressure by the pressing member during printing on the second surface of the sheet in duplex printing is second pressure, and in such a case, there is provided a fixing device that adjusts the second pressure to be lower than the first pressure.

### SUMMARY

In an image forming apparatus including such a fixing device, when a sheet containing a large amount of moisture is used for printing, the degree of curling that occurs when the sheet passes through the fixing nip is likely to increase. When the printed sheet is discharged to a discharge tray, the degree of curling of the sheet is large. In such a case, the sheets are not stacked properly on the discharge tray, and the sheet on the discharge tray is pushed out by the sheet discharged later or the sheets are curled on the discharge tray. As a result, the number of sheets that can be stacked on the discharge tray may be extremely reduced, that is, stacking performance may be deteriorated.

Further, for example, in a case where printing is performed on a sheet having a long length in a transport direction with respect to the fixing device, such as A3 paper, the stacking performance remarkably deteriorates. The reason is that, although the degree of curling does not change so much due to the length of the sheet (in the present disclosure, the length refers to the length along the transport direction in the image forming apparatus), the amount of movement of the sheet in the discharge tray may increase as the sheet is longer. Even when the degree of curling is small, a problem such as dropping of the sheet from the discharge tray is likely to occur.

Further, when duplex printing is performed on a sheet, the sheet is curled at the time of printing on the first surface in duplex printing, and the curled sheet is transported in the image forming apparatus and printing on the second surface is performed; therefore, a paper jam (JAM) may occur during transportation of the sheet.

As control of a fixing condition for suppressing curling of the sheet, it is effective to reduce pressure applied to the sheet at the fixing nip, that is, to weaken pressure of the pressing member; however, in order to fix toner on the sheet, it is necessary to raise fixing temperature instead of weakening the pressure of the pressing member. When the fixing temperature is increased, the fixing member is likely to deteriorate due to the high temperature, or energy efficiency of image formation is lowered. Therefore, it is desirable not to perform the control under an environment in which the control is not required. In a known image forming apparatus, a plurality of patterns of the fixing condition in which pressure reduction of the pressing member and fixing temperature correction accompanying the pressure reduction are combined as a set are prepared, and a service person can select an appropriate pattern in accordance with the degree of curling of a sheet. However, since such a selection is manually made in accordance with the degree of curling of the sheet, the control may be performed even under an environment in which the control is not required.

The disclosure has been made in view of the above-described problems, and an object thereof is to provide an image forming apparatus that can automatically perform control of a fixing condition for suppressing curling of a sheet under an environment in which the control is required.

To solve the above-described problems, the following image forming apparatus is provided. An image forming apparatus according to the disclosure includes a fixing device that includes: a fixing belt; a nip forming member that is disposed on one surface side of the fixing belt; a pressing member that presses the nip forming member from the other surface side of the fixing belt to form a fixing nip between the fixing belt and the pressing member and fix an image on a sheet conveyed to the fixing nip; a heat source that heats the fixing belt; and a pressure changing device that changes pressure applied to the nip forming member by the pressing member. The image forming apparatus includes: a humidity detection unit that detects ambient humidity of the image forming apparatus; and one or more controllers that control the heat source and the pressure changing device. The one or more controllers that have received image formation on one or a plurality of sheets as a print job determine whether to perform fixing condition change control, based on a humidity condition that the ambient humidity exceeds reference humidity and at least one of setting conditions of a sheet length setting and a duplex printing setting in the print job. The one or more controllers are allowed to perform control, as the fixing condition change control, of changing the pressure of the pressing member from first pressure when the ambient humidity is the reference humidity or lower to second pressure lower than the first pressure and increasing an amount of heat supplied by the heat source to be larger than an amount of heat when the ambient humidity is the reference humidity or lower.

In the image forming apparatus, when a state in which the ambient humidity exceeds the reference humidity continues for a predetermined period of time, the one or more controllers may determine that the humidity condition is satisfied.

Further, in the image forming apparatus, when printing is continuously performed on a plurality of sheets, the one or more controllers may gradually decrease the pressure by the pressing member and gradually increase the amount of heat supplied by the heat source every time a predetermined number of sheets pass through the fixing nip.

Furthermore, in the image forming apparatus, when determining that the fixing condition change control should be performed on a print job for performing duplex printing, the one or more controllers may perform the fixing condition change control at the time of printing on a first surface in duplex printing and need not perform the fixing condition change control at the time of printing on a second surface.

Additionally, the image forming apparatus described above may further include: a feed tray in which a sheet to be fed to the fixing device is stored; and a heater that heats the sheet stored in the feed tray. The controller need not perform the fixing condition change control when a predetermined period of time or more has elapsed after heating by the heater is started.

According to the image forming apparatus of the disclosure, in an environment in which control of a fixing condition for suppressing curling of the sheet is required, an excellent effect such as automatic execution of the control is achieved.

### BRIEF DESCRIPTION OF THE DRAWINGS

FIG. 1 is a schematic cross-sectional view of an image forming apparatus according to an embodiment of the disclosure when viewed from the front.

FIG. 2 is a front view illustrating a schematic configuration of a fixing device included in the image forming apparatus illustrated in FIG. 1.

FIG. 3 is a front view of a pressure changing device provided in the fixing device.

FIG. 4 is a system block diagram illustrating a control configuration of the image forming apparatus illustrated in FIG. 1.

FIG. 5 is a flowchart illustrating an example of a flow of determination processing on whether to perform fixing condition change control.

FIG. 6 is a graph illustrating a state in which a temperature difference between a fixing belt and a pressure roller increases with time during continuous printing.

### DESCRIPTION OF EMBODIMENTS

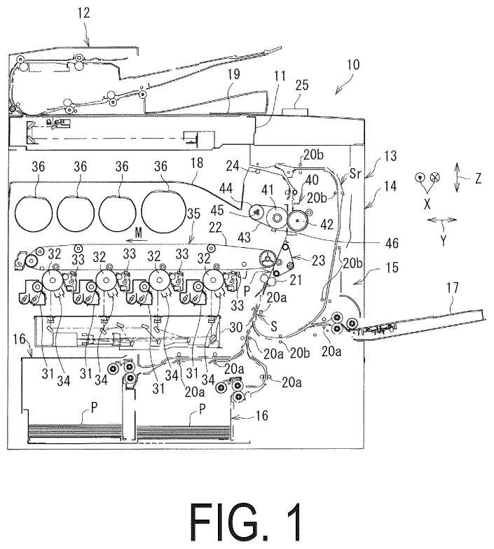

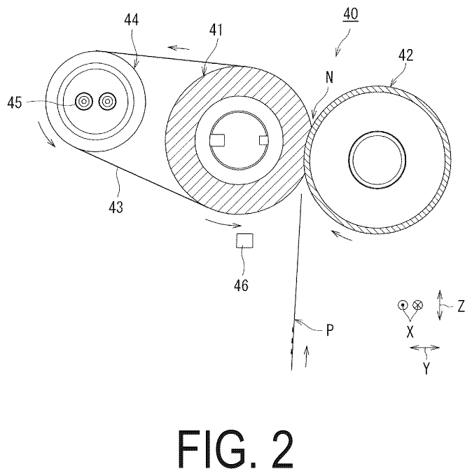

Embodiments according to the disclosure will be described in detail below with reference to the drawings. FIG. 1 illustrates an embodiment of the disclosure and is a schematic cross-sectional view of an image forming apparatus 10 when viewed from the front. Note that in FIG. 1, a reference sign X denotes the front-back direction (depth direction), a reference sign Y denotes the left-right direction (width direction), and a reference sign Z denotes the up-down direction (height direction). The same applies to FIG. 2.

The image forming apparatus 10 illustrated in FIG. 1 is a color image forming apparatus that forms a multicolor image or a monochrome image on a sheet P such as a recording sheet in accordance with image data read by an image reader 11 or image data transmitted from the outside. Note that the image forming apparatus 10 may be a monochrome image forming apparatus. In addition, the image forming apparatus 10 may be a color image forming apparatus of another configuration.

The image forming apparatus 10 includes a document feeder 12 and an image forming apparatus main body 13, and the image forming apparatus main body 13 includes an image former 14 and a sheet feeding system 15.

The image former 14 includes an exposure device 30 (specifically, an exposure unit of a writing optical system), a plurality of development devices 31 to 31 (specifically, developing units), a plurality of photoreceptor drums 32 to 32, a plurality of photoreceptor cleaners 33 to 33, a plurality of chargers 34 to 34, a primary transfer belt device 35, a plurality of toner cartridge devices 36 to 36 (specifically, toner cartridge units), and a fixing device 40 (specifically, a fixing unit). Further, the sheet feeding system 15 includes a feed tray 16, a manual feed tray 17 on which envelopes or the like are set, and a discharge tray 18.

A document table 19 made of transparent glass on which a document (not illustrated) is placed is provided at an upper portion of the image forming apparatus main body 13, and the image reader 11 for reading an image of the document is provided below the document table 19. Furthermore, the document feeder 12 is provided above the document table 19. The image of the document read by the image reader 11 is sent as image data to the image forming apparatus main body 13, and an image formed in the image forming apparatus main body 13 based on the image data is recorded on the sheet P. An operation display 25 (operation panel) is provided at a position near the document table 19.

The image data used in the image forming apparatus 10 corresponds to a color image made up of the colors (of black (K), cyan (C), magenta (M), and yellow (Y) in this example). Accordingly, a plurality (four in this example) of the development devices 31 to 31, a plurality (four in this example) of the photoreceptor drums 32 to 32, a plurality (four in this example) of the photoreceptor cleaners 33 to 33, a plurality (four in this example) of the chargers 34 to 34, and a plurality (four in this example) of the toner cartridge devices 36 to 36 are provided and set to black, cyan, magenta, and yellow, respectively, to form a plurality (four types in this example) of images corresponding to each color. Thus, a plurality of image stations (four image stations in this example) are configured.

In the image forming apparatus 10, when forming an image, a printing matter such as the sheet P is supplied from the feed tray 16 or the manual feed tray 17, and the sheet P is conveyed to registration rollers 21 by conveying rollers 20a to 20a provided along a sheet conveying path S. Next, at the timing when a toner image on the primary transfer belt 22 that is circularly moved in a circumferential direction M in the primary transfer belt device 35 and the sheet P are aligned with each other, the sheet P is conveyed by a secondary transfer belt device 23, and the toner image is transferred onto the sheet P. Thereafter, the sheet P is passed between a nip forming member (specifically, a fixing roller 41) and a pressing member (specifically, a pressure roller 42) of the fixing device 40; therefore, the unfixed toner on the sheet P is melted by heat and fixed, and the sheet P is discharged onto the discharge tray 18 via the conveying rollers 20a and a discharge roller unit 24. In addition, when performing image formation (printing) not only on the front surface but also on the back surface of the sheet P, that is, when performing duplex printing, the sheet P is conveyed in a reverse direction from the discharge roller unit 24 to a sheet reverse path Sr, and the front and back of the sheet P is reversed via conveying rollers 20b. Subsequently, the sheet P is guided once again to the registration rollers 21, a toner image is fixed on the back surface of the sheet P in the same manner as on the front surface of the sheet P, and the sheet P is discharged onto the discharge tray 18. Thus, the image forming apparatus 10 completes a series of printing operations. In other words, in the disclosure, “printing on the first surface in duplex printing” means image formation on the front surface of the sheet P, and “printing on the second surface in duplex printing” means image formation on the back surface of the sheet P.

Note that a monochrome image can be formed by using at least one of the four image forming stations and the monochrome image can be transferred to the primary transfer belt 22 in the primary transfer belt device 35. The monochrome image is transferred from the primary transfer belt 22 to the sheet P and fixed on the sheet P in the same way as a color image.

Next, a pressure changing device 50 applied to the fixing device 40 according to the present embodiment will be described. The fixing device 40 includes a plurality of belt rollers (a fixing roller 41 and a heating roller 44 in this example) and an endless belt (a fixing belt 43 in this example) wound around the plurality of belt rollers. The fixing belt 43 is configured to transfer heat from the heating roller 44 to the fixing roller 41.

FIG. 2 is a front view illustrating a schematic configuration of the fixing device 40. The fixing device 40 is configured such that the pressure roller 42 is pressed against the fixing roller 41 via the fixing belt 43, and the pressing portion forms a fixing nip N at which the sheet P is fixed. Further, the fixing belt 43 is heated by a heat source 45 disposed inside the heating roller 44, and is maintained at a predetermined fixing temperature based on a signal from a fixing temperature detection unit 46 (specifically, a temperature sensor such as a thermistor). Note that the fixing temperature detection unit 46 may be capable of detecting not only temperature but also humidity, and a humidity sensor may be provided separately from the temperature sensor. Furthermore, in FIG. 2, the rotation directions of the pressure roller 42 and the fixing belt 43 and the transport direction of the sheet P are indicated by arrows.

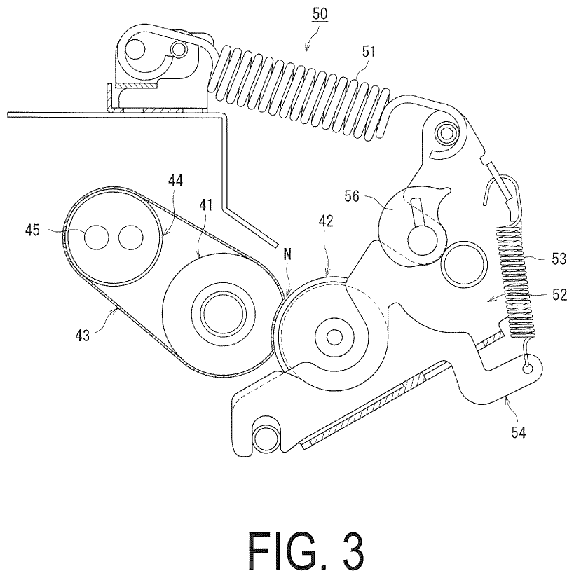

FIG. 3 is a front view of the pressure changing device 50 provided in the fixing device 40. The pressure changing device 50 adjusts roller pressure of the pressure roller 42 toward the fixing roller 41. The pressure changing device 50 includes a first pressure lever 52 that can contact the pressure roller 42 by receiving biasing force from a first biasing member 51, and a second pressure lever 54 that contacts the pressure roller 42 by receiving biasing force from a second biasing member 53 having the biasing force smaller than that of the first biasing member 51. The second biasing member 53 is stretched between the levers 52 and 54. The first pressure lever 52 is rotated by rotation of an eccentric cam 56, and thus the biasing force from each of the biasing members 51 and 53 is changed to change the roller pressure. The rotating position of the eccentric cam 56 is regulated in accordance with the thickness of printing matters, and thus optimal roller pressure is obtained.

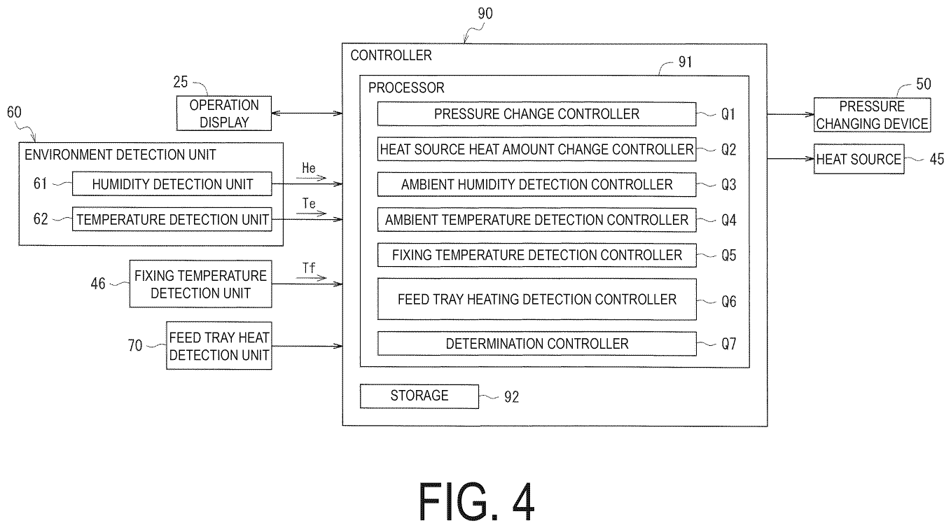

FIG. 4 is a system block diagram illustrating an example of a control configuration of the image forming apparatus 10. A controller 90 controls the entirety of the image forming apparatus 10. The controller 90 realizes various functions by reading and executing various programs stored in a storage 92 (for example, a storage or ROM). The controller 90 may be implemented by one or more control devices/arithmetic devices (central processing unit (CPU) or system on a chip (SoC)). In addition, the controller 90 may include one or more control circuits. The controller 90 includes a processor 91 including a microcomputer such as a CPU, and a storage 92 including a nonvolatile memory such as a ROM and a volatile memory such as a RAM. The processor 91 loads a control program stored in advance in the ROM of the storage 92 onto the RAM of the storage 92 and executes the control program, and thus the controller 90 performs operation control of various components.

The operation display 25 receives an operation instruction (operation data) from a user and outputs the received operation instruction to the controller 90. In addition, the operation display 25 displays a variety of information based on display information (display data) output from the controller 90.

### First Embodiment

The controller 90 controls the heat source 45 and the pressure changing device 50. In this example, the controller 90 includes a pressure change controller Q1 that controls the pressure changing device 50 (i.e., pressure applied to the fixing roller 41 by the pressure roller 42), and a heat source heat amount change controller Q2 that controls the amount of heat supplied by the heat source 45. Thus, the controller 90 can perform fixing condition change control. When an ambient environment of the image forming apparatus 10 is an environment in which the sheet P is curled when passing through the fixing nip N, the controller 90 performs the fixing condition change control. Therefore, the sheet P can be prevented from being curled.

As the fixing condition change control, the controller 90 changes the pressure of the pressure roller 42 (pressing member) to the fixing roller 41 (nip forming member) from first pressure when ambient humidity of the image forming apparatus 10 is reference humidity or lower to second pressure lower than the first pressure, and increases the amount of heat supplied by the heat source 45 to be larger than the amount of heat when the ambient humidity is the reference humidity or lower. By performing this control, the pressure applied to the sheet P at the fixing nip N can be reduced, and thus curling of the sheet P can be suppressed.

On the other hand, in this control, in order to fix toner onto the sheet P, the amount of heat supplied by the heat source 45 is increased to raise fixing temperature. Therefore, when the sheet P is not curled or when the curl does not become a problem, it is desirable not to perform this control as much as possible. Accordingly, the members included in the fixing device 40 are prevented from being thermally damaged as much as possible, and thus the life of the members can be extended and energy of the image forming apparatus 10 can be saved.

Incidentally, in an image forming apparatus including a fixing device, when a sheet containing high moisture content is used for printing, the degree of curling that occurs when the sheet passes through a fixing nip is likely to increase. The moisture content of the sheet is affected by humidity of an environment in which the sheet is placed.

In addition, deterioration of stacking performance of the sheet becomes evident when printing is performed on a sheet that is long along a transport direction with respect to the fixing device. This is because, when the sheet is long, the amount of movement of the sheet in a discharge tray increases, and a problem such as dropping of the sheet from the discharge tray is likely to occur even when the degree of curling is small. The deterioration of stacking performance due to the length of the sheet becomes evident when the ambient humidity exceeds a certain threshold value. Hereinafter, this threshold value is referred to as a first threshold value.

In addition, when performing duplex printing on a sheet, the sheet is curled when printing on the first surface in duplex printing, and the curled sheet is transported in the image forming apparatus and printing on the second surface is performed. Therefore, a paper jam (JAM) may occur during transportation of the sheet. The occurrence of JAM during duplex printing also becomes evident when the ambient humidity exceeds a certain threshold. Hereinafter, this threshold value is referred to as a second threshold value.

Therefore, whether or not the stacking performance is deteriorated or JAM occurs due to curling of the sheet can be classified and determined by a humidity condition that the ambient humidity of the image forming apparatus exceeds the reference humidity and at least one of setting conditions of a sheet length setting and a duplex printing setting in a print job.

In other words, in the present embodiment, the controller 90 that has received image formation on one or a plurality of sheets P as a print job determine whether to perform the fixing condition change control based on the humidity condition that the ambient humidity of the image forming apparatus 10 exceeds the reference humidity and at least one of the setting conditions of the sheet length setting and the duplex printing setting in the print job. By determining as just described, the fixing condition change control can be automatically performed under an environment in which the control is required, and the control can be prevented from being performed as much as possible under an environment in which the control is not required.

In order to enable determination to be performed based on the ambient humidity of the image forming apparatus 10, the image forming apparatus 10 includes an environment detection unit 60 (see FIG. 4) that detects the ambient environment of the image forming apparatus 10. In the image forming apparatus 10, the environment detection unit 60 is disposed at a position away from a device such as the fixing device 40, which generates heat, in order to detect the ambient environment of the image forming apparatus 10.

The environment detection unit 60 includes a humidity detection unit 61 that detects ambient humidity He of the image forming apparatus 10. The controller 90 determines based on a detection result of the humidity detection unit 61 whether or not the humidity condition that the ambient humidity He exceeds the reference humidity is satisfied. The reference humidity used for determination is set in advance by experiment or the like, and is stored in advance in the storage 92.

In this example, the environment detection unit 60 includes, in addition to the humidity detection unit 61, a temperature detection unit 62 that detects an ambient temperature Te of the image forming apparatus 10. In addition, the controller 90 includes an ambient humidity detection controller Q3 that detects the ambient humidity He from a detection signal of the humidity detection unit 61, an ambient temperature detection controller Q4 that detects the ambient temperature Te from a detection signal of the temperature detection unit 62, and a determination controller Q7 that determines whether to perform the fixing condition change control.

The controller 90 preferably determines whether to perform the fixing condition change control based on the humidity condition that the ambient humidity He exceeds the reference humidity and both the setting conditions of the sheet length setting and the duplex printing setting. In this case, two reference humidities are provided, and specifically, first reference humidity related to the sheet length setting and second reference humidity related to the duplex printing setting are provided. The first reference humidity is set based on the first threshold value, and the second reference humidity is set based on the second threshold value.

Table 1 below is an example of classifications of whether or not the controller 90 in the image forming apparatus 10 according to the present embodiment performs the fixing condition change control. In Table 1, “JAM present” means that the condition is likely to cause a jam, and “Stacking deterioration” means that the condition is likely to cause stacking deterioration. In this example, the first reference humidity related to the sheet length setting is 60%, and the second reference humidity related to the duplex printing setting is 70%.

TABLE 1

| | A4 paper (Less than | | A3 paper (Length | |
|---|---|---|---|---|
| | length 300 mm) | | 300 mm or longer) | |
| | Single-sided | Double-sided | Single-sided | Double-sided |
| | printing | printing | printing | printing |
| Ambient | No | JAM | Stacking | JAM |
| humidity He | problem | present | deterioration | (+Stacking |
| More than | | | | deterioration) |
| 70% | | | | |
| Ambient | No | No | Stacking | Stacking |
| humidity He | problem | problem | deterioration | deterioration |
| More than | | | | (JAM is not a |
| 60% and | | | | problem) |
| 70% or less | | | | |
| Ambient | No | No | No problem | No problem |
| humidity He | problem | problem | | |
| 60% or less | | | | |

When the determination result corresponds to the classification of “JAM present” and “Stacking deterioration” in Table 1, the determination controller Q7 in the controller 90 determines that the fixing condition change control should be performed. When the determination result corresponds to the classification of “No problem” in Table 1, the determination controller Q7 in the controller 90 determines that the fixing condition change control should not be performed.

In addition, when the sheet is long (in this example, the sheet is A3 paper), the problem of the ambient humidity He that stacking deteriorates in single-sided printing is common to double-sided printing. Therefore, when the ambient humidity He exceeds the first reference humidity (60%), the controller 90 can determine that the fixing condition change control should be performed regardless of single-sided printing or double-sided printing. An example of processing of this determination will be described below.

### EXAMPLES

Here, Example of the image forming apparatus 10 that performs the fixing condition change control according to the classifications of Table 1 will be described. The fixing device 40 included in the image forming apparatus 10 in Example includes the fixing roller 41 having a diameter of 25 mm, the pressure roller 42 having a diameter of 20 mm, and the fixing belt 43 having a diameter of 40 mm. The fixing device 40 is configured such that the pressure roller 42 is pressed against the fixing roller 41 via the fixing belt 43, and the pressing portion forms the fixing nip N at which the sheet P is fixed. The toner on the sheet P is fixed by temperature and pressure when the sheet P passes through the fixing nip N (that is, sheet passing is allowed). A fixing lamp as the heat source 45 is provided inside the heating roller 44. The controller 90 controls lighting of the fixing lamp, and thus the temperature of the fixing belt 43 is maintained at a predetermined fixing temperature. In this example, the controller 90 includes a fixing temperature detection controller Q5 (see FIG. 4) that detects a fixing temperature Tf from a detection signal of the fixing temperature detection unit 46. The effective length of the fixing roller 41, the pressure roller 42, and the heating roller 44 excluding the bearings is 330 mm, and the length of the fixing belt 43 is 320 mm.

When the determination controller Q7 in the controller 90 determines that the fixing condition change control should not be performed, image formation on the sheet P is performed under the first fixing condition that is a normal fixing condition. In this example, the first fixing condition is a condition that the pressure by the pressure roller 42 (pressure at the fixing nip N) is about 343 N (35 kgf), the fixing nip width at the fixing nip Nis 7 mm, and the adjusted temperature of the fixing belt 43 at the time of sheet passing is 150° C.

When the determination controller Q7 in the controller 90 determines that the fixing condition change control should be performed, image formation on the sheet P is performed under the second fixing condition different from the first fixing condition. In this example, the second fixing condition is a condition that the pressure by the pressure roller 42 (pressure at the fixing nip N) is about 245 N (25 kgf), the fixing nip width at the fixing nip Nis 5 mm, and the adjusted temperature of the fixing belt 43 at the time of sheet passing is 170° C.

As described above, in the image forming apparatus 10, as the fixing condition change control, control is performed in which the pressure by the pressure roller 42 is changed to be lower than usual and the adjusted temperature of the fixing belt 43 is changed to be higher than usual (that is, the amount of heat supplied by the heat source 45 is increased to be larger than usual). By changing the fixing condition from the first fixing condition to the second fixing condition, the fixing temperature is increased by the amount corresponding to a decrease in the fixing nip width, and the amount of heat applied to the toner is approximated. The amount of heat applied to the sheet P decreases as the fixing nip width decreases, and thus curling of the sheet P is suppressed. In other words, the fixing condition change control functions as curling suppression control of the sheet P.

### Example of Processing

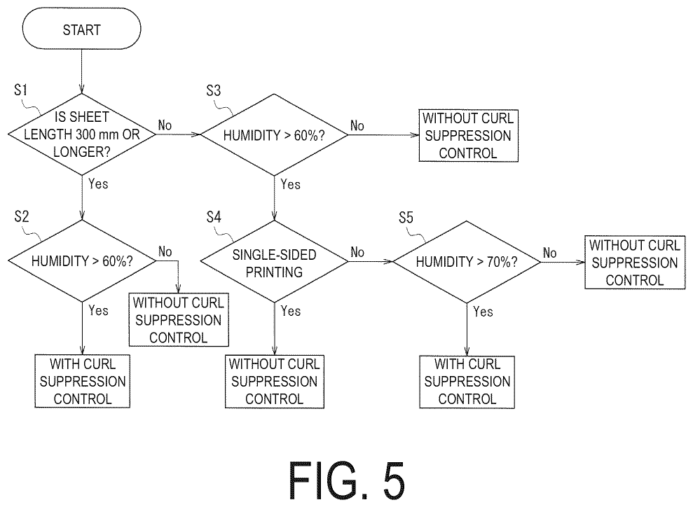

Next, an example of determination processing on whether to perform the fixing condition change control will be described below with reference to FIG. 5. FIG. 5 is a flowchart illustrating an example of a flow of determination processing on whether to perform the fixing condition change control. Note that as described above, the fixing condition change control in the present disclosure functions as the curling suppression control, and thus the fixing condition change control is simply described as the curling suppression control in this flowchart.

As illustrated in FIG. 5, the controller 90 that has received image formation on one or a plurality of sheets P as a print job first determine whether or not the length of the sheet P is a reference length (300 mm in this example) or longer (S1).

When determining that the length of the sheet P is the reference length or longer (S1: Yes), the controller 90 determines whether or not the ambient humidity He exceeds the first reference humidity (60% in this example) (S2). When determining that the ambient humidity He exceeds the first reference humidity (S2: Yes), the controller 90 performs the fixing condition change control at the time of forming an image on the sheet P. In other words, the image is formed on the sheet P under the second fixing condition (fixing condition different from the normal fixing condition). When determining that the ambient humidity He is the first reference humidity or lower (S2: No), the controller 90 does not perform the fixing condition change control at the time of forming an image on the sheet P. In other words, the image is formed on the sheet P under the first fixing condition (normal fixing condition).

When determining that the length of the sheet P is less than the reference length (S1: No), the controller 90 determines whether or not the ambient humidity He exceeds the first reference humidity (60% in this example) (S3). When it is determined that the ambient humidity He exceeds the first reference humidity (S3: Yes), the processing shifts to S4. When determining that the ambient humidity He is the first reference humidity or lower (S3: No), the controller 90 does not perform the fixing condition change control at the time of forming an image on the sheet P. In other words, the image is formed on the sheet P under the first fixing condition.

In S4 illustrated in FIG. 5, it is determined whether the print job is single-sided printing or double-sided printing. When the print job is single-sided printing (S4: Yes), the controller 90 does not perform the fixing condition change control at the time of forming an image on the sheet P. In other words, the image is formed on the sheet P under the first fixing condition. When the print job is duplex printing (S4: No), the processing shifts to S5.

In S5 illustrated in FIG. 5, it is determined whether or not the ambient humidity He exceeds the second reference humidity (70% in this example). When determining that the ambient humidity He exceeds the second reference humidity (S5: Yes), the controller 90 performs the fixing condition change control at the time of forming an image on the sheet P. In other words, the image is formed on the sheet P under the second fixing condition. When determining that the ambient humidity He is the second reference humidity or lower (S5: No), the controller 90 does not perform the fixing condition change control at the time of forming an image on the sheet P. In other words, the image is formed on the sheet P under the first fixing condition.

According to the above example of determination processing on whether to perform the fixing condition change control, determination can be performed in accordance with the classifications indicated in Table 1.

### Second Embodiment

Curling of the sheet P is affected by moisture contained in the sheet, and the degree of curling occurring when the sheet P passes through the fixing nip Nis likely to increase as the moisture content is larger. However, in order that the sheet P contains moisture to the extent that the sheet is curled, a state in which the ambient humidity He is high needs to continue for a while.

In this regard, in the present embodiment, when a state in which the ambient humidity He exceeds the reference humidity continues for a predetermined period of time, the controller 90 determines that a humidity condition in the determination of whether to perform the fixing condition change control is satisfied.

According to this configuration, the fixing condition change control (that is, the curling suppression control) can be prevented from being performed before the sheet P contains moisture to be prone to curling. In addition, the members included in the fixing device 40 are prevented from being thermally damaged, and thus the life of the members can be extended and energy of the image forming apparatus 10 can be saved.

As described with the example of determination processing illustrated in FIG. 5, determination is made as Yes when the ambient humidity He is higher than the first reference humidities (60% in this example) for a predetermined period of time (for example, 12 hours) in S2 and S3. In addition, determination may be made as Yes in S5 when the ambient humidity He exceeds the second reference humidity (70% in this example) for a predetermined period of time (for example, 12 hours), or determination may be made as Yes in S5 without the condition that the predetermined period of time continues. The predetermined period of time in S2 and S3 may be different from the predetermined period of time in S5.

### Third Embodiment

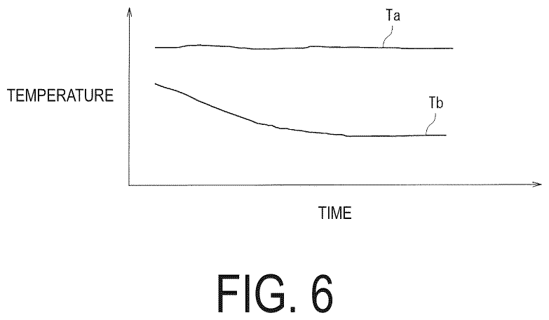

FIG. 6 is a graph illustrating a state in which a temperature difference between the fixing belt 43 and the pressure roller 42 increases with time during continuous printing. In FIG. 6, Ta indicates the temperature of the fixing belt 43, and Tb indicates the temperature of the pressure roller 42.

The pressure roller 42 receives heat from the fixing belt 43 to be heated; however, when printing is continuously performed on a plurality of sheets P (continuous sheet passing is performed), the supply of heat from the fixing belt 43 to the pressure roller 42 is blocked and stopped by the sheets P. Therefore, the temperature of the pressure roller 42 decreases with time. As a result, as illustrated in FIG. 6, the temperature difference between the fixing belt 43 and the pressure roller 42 increases with time. When the temperature difference between the fixing belt 43 and the pressure roller 42 increases, one surface side of the sheet P passing through the fixing nip Nis heated more than the other surface side, and the degree of curling of the sheet P increases because a bias in heating with respect to the sheet P increases.

In this regard, in the present embodiment, when printing is continuously performed on a plurality of sheets P, the controller 90 gradually decreases the pressure by the pressing member (in this example, the pressure roller 42) and gradually increases the amount of heat supplied by the heat source 45 every time a predetermined number of sheets pass through the fixing nip N.

According to this configuration, as the number of sheets to be continuously fed increases, the effect of suppressing curling in the fixing condition change control can be increased. In other words, even when the number of sheets to be continuously fed increases, curling of the sheets P can be suppressed. In addition, in a state where the number of sheets to be continuously fed is small, the amount of heat supplied by the heat source 45 can be suppressed to be small. Therefore, the members included in the fixing device 40 are prevented from being thermally damaged, and thus the life of the members can be extended and energy of the image forming apparatus 10 can be saved.

### Fourth Embodiment

Incidentally, at the time of duplex printing, curling of the sheet P occurs in printing on the first surface. Therefore, when curling of the sheet P is suppressed in printing on the first surface, the foregoing problems of deterioration of stacking performance and JAM in printing on the second surface are not caused.

In this regard, in the present embodiment, when determining that the fixing condition change control should be performed on a print job for performing duplex printing, the controller 90 performs the fixing condition change control at the time of printing on the first surface in duplex printing and does not perform the fixing condition change control at the time of printing on the second surface.

According to this configuration, the number of times that the fixing condition change control is performed is reduced, and thus the number of times that the amount of heat supplied by the heat source 45 is increased (that is, the number of times that the fixing temperature is increased) is also reduced. Accordingly, the members included in the fixing device 40 are prevented from being thermally damaged, and thus the life of the members can be extended and energy of the image forming apparatus 10 can be saved.

### Fifth Embodiment

The image forming apparatus 10 according to the present embodiment includes a heater (cassette heater) that heats the sheets P stored in the feed tray 16 (see FIG. 1). Additionally, in this example, the image forming apparatus 10 includes a feed tray heat detection unit 70 (see FIG. 4) that detects heat applied to the feed tray 16 (detects that the heater is turned on), and the controller 90 includes a feed tray heating detection controller Q6 (see FIG. 4) that detects a detection signal from the feed tray heat detection unit 70.

The heater has the effects of preventing the sheets P from absorbing moisture and releasing the moisture contained in the sheets P by keeping the sheets P stored in the feed tray 16 warm. A certain amount of time is required from the start of heating by the heater until moisture is released from the sheets P to the extent that curling does not occur during printing.

In this regard, in the present embodiment, the controller 90 does not perform the fixing condition change control when a predetermined period of time or more has elapsed from the start of heating by the heater. The predetermined period of time may be, for example, 24 hours.

According to this configuration, when the suppression of curling of the sheet P by the heater is not required, the fixing condition change control is not performed. Accordingly, the members included in the fixing device 40 are prevented from being thermally damaged, and thus the life of the members can be extended and energy of the image forming apparatus 10 can be saved.

The embodiments disclosed herein are illustrative in all respects and do not form the basis for a limited interpretation. Accordingly, the technical scope of the disclosure is not to be construed only by the foregoing embodiments, and is defined based on the description of the claims. In addition, meanings equivalent to the claims and all changes made within the claims are included.

1. An image forming apparatus, comprising:
a fixing device that comprises:
a fixing belt;
a nip forming member that is disposed on one surface side of the fixing belt;
a pressing member that presses the nip forming member from the other surface side of the fixing belt to form a fixing nip between the fixing belt and the pressing member and fix an image on a sheet conveyed to the fixing nip;
a heat source that heats the fixing belt; and
a pressure changing device that changes pressure applied to the nip forming member by the pressing member,
the image forming apparatus comprising:
a humidity detection unit that detects ambient humidity of the image forming apparatus; and
one or more controllers that control the heat source and the pressure changing device,
wherein the one or more controllers that have received image formation on one or a plurality of sheets as a print job determine whether to perform fixing condition change control, based on a humidity condition that the ambient humidity exceeds reference humidity and at least one of setting conditions of a sheet length setting and a duplex printing setting in the print job, and
the one or more controllers are allowed to perform control, as the fixing condition change control, of changing the pressure of the pressing member from first pressure when the ambient humidity is the reference humidity or lower to second pressure lower than the first pressure and increasing an amount of heat supplied by the heat source to be larger than an amount of heat when the ambient humidity is the reference humidity or lower.

2. The image forming apparatus according to claim 1, wherein when a state in which the ambient humidity exceeds the reference humidity continues for a predetermined period of time, the one or more controllers determine that the humidity condition is satisfied.

3. The image forming apparatus according to claim 1, wherein when printing is continuously performed on a plurality of sheets, the one or more controllers gradually decrease the pressure by the pressing member and gradually increase the amount of heat supplied by the heat source every time a predetermined number of sheets pass through the fixing nip.

4. The image forming apparatus according to claim 1, wherein when determining that the fixing condition change control should be performed on a print job for performing duplex printing, the one or more controllers perform the fixing condition change control at the time of printing on a first surface in duplex printing and do not perform the fixing condition change control at the time of printing on a second surface.

5. The image forming apparatus according to claim 1, further comprising:
a feed tray in which a sheet to be fed to the fixing device is stored; and
a heater that heats the sheet stored in the feed tray,
wherein the one or more controllers do not perform the fixing condition change control when a predetermined period of time or more has elapsed after heating by the heater is started.
